(19) United States
(12) Patent Application Publication
(10) Pub. No.: US 2002/0069251 A1
(43) Pub. Date: Jun. 6, 2002

(54) Method and system for high-speed transfer of data between two computers using a common target

(76) Inventors: Homer Carter, Reno, NV (US); Antony Harris, Reno, NV (US)

Correspondence Address: Barbara J. Luther, Chartered, 18124 Wedge Parkway, PMB 516, Reno, NV, 89511-8134, US

(21) Appl. No.: 09/884,621

(22) Filed: Jun. 18, 2001

Related U.S. Application Data
(60) Provisional application No. 60/251,346, filed on Dec. 4, 2000.

(51) Int. Cl. G06F 15/16

(52) U.S. Cl. 709/206

(57) ABSTRACT

The instant invention is an improved method of transferring information between two or more computers each connected to a target. This method includes selecting a set of data in a first computer, opening a connection between the first computer and the target, writing the selected data to the target. The sender informs a data recipient of the transfer, block address and block size. The recipient then opens a connection between the second computer and the target and reads the data from the target. The method provides for indirect data transmission in block mode at high speed. The system provides a means for transferring information between at least two computers, each with a computer processor means for processing data, storage means for storing data on a storage medium, an independent device connected to each of the at least two computers, and access to transmission means the system. The system provides means for selecting a set of data in the first computer, means for opening a connection between the first computer and a device, means for the first computer to write the data set to the device in block form, means in the device for at least temporarily saving the data set, means for a second computer to open a connection between the second computer and the device, means for the second computer to read the data set in the device. In addition, the method can be combined with any application requiring data transfers.

This application takes the benefit of U.S. Provisional Application No. 60/251,346, filed Dec. 4, 2000.

### FIELD OF THE INVENTION

The present invention relates to a method and apparatus for the purpose of transferring data from the memory of one computer to the memory of another computer.

### BACKGROUND OF THE INVENTION

Computers today are plagued, in many cases, with the inability to use the raw speed of physical connections (called the “wire”) between them to exchange data. In data intensive industries, such as film and video, this inefficiency in the presence of the need to transfer vast amounts of data between heterogeneous sets of computers, costs the industry millions in lost productivity.

Two computers commonly use a computer network, comprised of both a physical connection and a set of rules, called protocols, to form a logical connection across which data can be transferred. Long experience has shown that in nearly all networks, operating system and protocol overhead dominate the actual time the wire is in use [Computer Networks pp 562, Tanenbaum et al. Prentice Hall, New Jersey, 1996].

Communication protocols are generally byte-oriented, where processing of each byte is performed, such as that found in the Internet Protocol. However, much more efficient block-oriented, transfer protocols have been designed that exchange data with peripherals such as the Small Computer Systems Interface (SCSI) protocol.

As an example, consider the overhead involved in moving data over a network using the Internet Protocol. The network layer protocol, Internet Protocol (IP), is combined with Transmission Control Protocol (TCP) to form a TCP/IP service model. The IP layer has a header that defines a datagram that in theory can be up to 65,535 bytes. The TCP layer also has a header and defines an actual transfer size, referred to as a segment. Two limits restrict the segment size. First, each segment, including the TCP header, must fit in the 65,535 byte IP payload. Second, each network has a maximum transfer unit or MTU and the segment must fit in the MTU. In practice the TCP segment size is about 1500 bytes but it can be as small as 556 bytes. Each segment that is sent over the network must be acknowledged which introduces a round trip propagation delay plus the processing time of the acknowledgement. The sender is idle while waiting for acknowledge. In contrast, typical SCSI protocols will allow up to 32 Megabytes in a single transfer. In practice, one can observe a four to five times the quantity of data transferred using SCSI protocol than using the IP protocol in a given amount of time.

It would be desirable, therefore, to have an alternate method and system for implementing block data transfers between computers without the overhead of byte-oriented protocols and without compatibility issues with using block-oriented protocols directly between computers.

### SUMMARY OF THE INVENTION

It is an object of the present invention to provide a method and system for transferring data between two computers using device commands to a third peripheral device in an initiator/target model. The two computers are initiators and the peripheral device is a target.

It is another object of the present invention to provide a method and system for transferring data between two computers that are connected to a common target. One computer writes data into the target and the other computer reads data from the target. Persistent data is not stored in the target.

It is another object of the present invention to provide a method and system for transferring blocks of data between two computers at higher performance than existing communication protocols that are based on byte streams.

It is another object of the present invention to provide a method and system to provide wider compatibility than existing point-to-point, block-oriented networks and protocols.

These and other objects, which will become apparent as the invention is more fully described below, are obtained by an improved method and system of transferring data from the memory of one computer to the memory of another computer.

Disclosed herein is an improved method of transferring information between two or more computers each connected to a target. This method has the following steps: a) selecting a set of data in a first computer; b) opening a connection between the first computer and the target; c) writing the selected data to the target; d) informing a data recipient of the transfer, block address and block size; e) opening a connection between the second computer and the target; and f) reading the data by the second computer from the target. This method enables indirect data transmission in block mode at high speed.

Also disclosed is a system for transferring information between at least a first and a second computer, each with a computer processor means for processing data, storage means for storing data on a storage medium, an independent device connected to each of the at least two computers, and access to transmission means. The system also includes the following: a) means for selecting a set of data in the first computer; b) means for opening a connection between the first computer and a device; c) means for the first computer to write the data set to the device in block form; d) means in the device for at least temporarily saving the data set; e) means for a second computer to open a connection between the second computer and the device; and f) means for the second computer to read the data set in the device.

In another embodiment, a computer application including a browser, office suite or email system also includes the inventive method for transferring information indirectly between two or more computers utilizing an independent device.

### BRIEF DESCRIPTION OF THE DRAWINGS

FIG. 1 is a drawing that details the most basic form of the present invention.

### DETAILED DESCRIPTION OF THE INVENTION

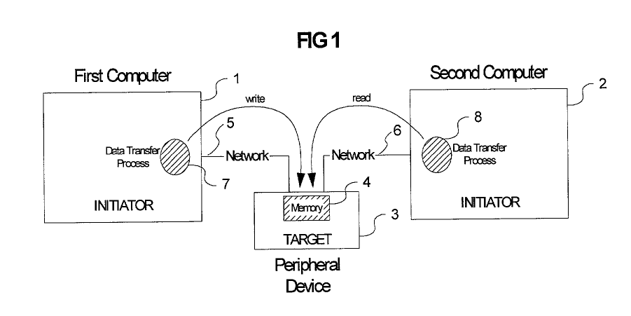

The present invention provides a method and system for transferring data between a first computer and a second computer using a common target. In a preferred embodiment, the common target is a peripheral disk device. With reference to FIG. 1 the first computer (1) operates as an initiator and is connected to a device (3) that operates as a target. The second computer (2) is concurrently connected to the device (3) and also operates as an initiator. The initiator and target use device commands to transfer data between computer memory and device memory. Each computer is an independent initiator that transfers data to or from a common target. For example, the first computer can write data to the target, and the second computer can read data from the target. The two computers do not address each other to send and receive data, instead addressing the memory in the common target.

An aspect of the data transfer method is that the target does not store persistent data. Subsequent transfers overwrite the previous transfers in the target memory. While it is not a requirement of the present invention, maximum performance is achieved when the target memory operates in full duplex mode.

Another aspect of the data transfer method is that data transferred to the target memory is not required to have an ordered structure. The most basic transfer occurs when the first computer addresses the target and transfers data into the memory of the target device. Then a second computer addresses the target and transfers data from the memory of the target device.

Since all major computer operating systems provide the basic capability to transfer data to and from a peripheral disk device, diverse computer systems can exchange data through the common target.

Network Connections

FIG. 1 describes how a network (5) connects the first computer to a peripheral device. The second computer is connected to the peripheral by another network (6). The network in this example could be a simple SCSI cable and the target could be a SCSI compatible device such as a disk that contains cache memory.

Another example of the configuration is a Fibre Channel network with the computers and target connected to a Fibre Channel hub or switch. A Fibre Channel network supports several protocols including SCSI. The first computer and second computer communicate with the target using SCSI protocol mapped onto the Fibre Channel network.

Signaling

A signaling methodology is implemented that controls the writing and reading of the common target. The signaling process commands one computer to write data to a common target and then commands a second computer to read data from the target. The signaling process can be implemented in many different ways. It generally takes the form of a peer-to-peer communication session between the two computers that are connected to the common target. A preferred embodiment of the present invention uses the common target for bulk data transfers and a separate communication link such as Ethernet to implement the signaling communication session.

Exemplary Use

The foregoing invention provides a system and method for transferring the increasingly larger sets of data, such as in digital film processing. The increased speed allows more projects to be completed in the same amount of time.

Using standard computer commands, the sender uses his computer to select the data to be sent, to open the computer connection to the target, and to write the data to an address in the target. The sender also informs the recipient by convenient means (see above) that the data is being or has been sent to the target and the data block's size and location in the target.

The recipient then uses his computer to open the connection to the target, read the located data block from the target. If the same location in the target is always used, the sender only needs to inform the recipient of the block size.

It is to be noted here that, besides those already mentioned above, many modifications and variations of the above embodiments can be made without departing from the novel and advantageous features of the present invention. Accordingly, all such modifications and variations are intended to be included within the scope of the appended claims.

We claim:

1. An improved method of transferring information between two or more computers each connected to a target, the method comprising:
a) selecting a set of data in a first computer;
b) opening a connection between the first computer and the target;
c) writing the selected data to the target;
d) informing a data recipient of the transfer, block address and block size;
e) opening a connection between the second computer and the target; and
f) reading the data by the second computer from the target;
whereby the data have been transmitted indirectly in block mode at high speed.

2. A system for transferring information between at least a first and a second computer, each with a computer processor means for processing data, storage means for storing data on a storage medium, an independent device connected to each of the at least two computers, and access to transmission means, the system further comprising
a) means for selecting a set of data in the first computer;
b) means for opening a connection between the first computer and a device;
c) means for the first computer to write the data set to the device in block form;
d) means in the device for at least temporarily saving the data set;
e) means for a second computer to open a connection between the second computer and the device; and
f) means for the second computer to read the data set in the device.

3. A computer application including a browser, office suite or email system comprising a method for transferring information indirectly between two or more computers utilizing an independent device, the method comprising the method of claim 1.
